(19) United States
(12) Patent Application Publication
(10) Pub. No.: US 2008/0002223 A1
(43) Pub. Date: Jan. 3, 2008

(54) Image processing apparatus

(75) Inventors: Yuji Okamoto, Kyoto (JP); Naofumi Ueda, Kyoto (JP); Tsutomu Yoshimoto, Nara (JP); Syoichiro Yoshiura, Nara (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 11/811,374

(22) Filed: Jun. 8, 2007

(30) Foreign Application Priority Data
Jun. 9, 2006 (JP) 2006-160881

(51) Int. Cl. G06F 3/12

(52) U.S. Cl. 358/1.15; 358/1.1

(57) ABSTRACT

The image processing apparatus according to the present invention behaves as if a security function is provided even if the security function is not provided so as to curb unauthorized use by a third party. In a copy mode, it reads image data of a document and stores inputted image data in a hard disk drive. It prints the image data. Once the printing is finished, the image data is erased in the case where the security function is provided. However, the image data is not erased because the security function is not provided. In this case, it behaves as if the security function is being executed by indicating that the image data is being erased on an operation screen.

### BACKGROUND OF THE INVENTION

1. Field of the Invention

The present invention relates to an image processing apparatus for performing processes such as copying, printing and data transmission of image data.

2. Description of the Related Art

An image processing apparatus performs a variety of image processing, such as a copy mode, a print mode, a scanner mode and a facsimile mode. Such an image processing apparatus is connected to a server or a personal computer through a network so as to transmit and receive image data. For that reason, there is an increasing danger of leaking the image data due to unauthorized access and invalid operation from outside.

Thus, the image processing apparatus has a security function to prevent leakage of the image data. The image processing apparatus makes an appeal as to its security function by labeling it or displaying a security mark on an operation screen. As described in Japanese Patent Laid-Open No. 2005-204242 for instance, it is indicated on the operation screen that the security function is being executed during image processing operation. A user can have a sense of ease by recognizing execution of the security function. It also has an effect of curbing unauthorized use of a third party.

As for an image processing apparatus which does not have the security function, no indication is performed as to security. Therefore, it is easy to discern whether or not the apparatus has the security function. For that reason, a malicious third party can easily obtain the image data by finding the image processing apparatus without the security function and performing invalid operation.

Thus, in view of the above, an object of the present invention is to provide an image processing apparatus that can curb the unauthorized use by a third party even though it does not have the security function.

### SUMMARY OF THE INVENTION

The present invention includes: a processing section for processing image data; an input section for receiving an input of an operating instruction; and a disguise section for behaving as if executing an unprovided function when the processing section operates based on the operating instruction.

When a third party provides an operating instruction, the third party recognizes that some function is being executed due to operation of the disguise section. However, the third party is not aware that the function in execution is not being executed in reality. For that reason, the third party who has attempted an invalid operation stops the operation by way of precaution. Thus, unauthorized use by the third party is curbed.

Here, the disguise section announces by display, voice or the like that a security function related to processing of image data is being executed. The third party recognizes that this image processing apparatus has the security function to prevent leakage of the image data. Consequently, the third party gives up the unauthorized use.

The processing section reads the image data from a document, and the disguise section operates during processing of the read image data. To be more specific, it is announced that the security function such as encryption of image data is being executed when storing inputted image data in a copy mode or a scanner mode.

The processing section prints the image data, and the disguise section operates on printing. To be more specific, it is announced that the security function such as erasure of the stored image data is being executed when the image data is printed in the copy mode or a print mode.

The disguise section operates on start-up. To be more specific, on start-up, it is announced that initialization is performed and the security function such as erasure of the remaining image data is being executed. When the third party turns on power and starts it up, this annunciation can make the third party recognize that the security function is provided and give up the operation thereafter.

The input section displays a setting screen of the provided functions, and the disguise section displays a setting screen for the security function on the setting screen of thr provided function. And the input section allows the operation on the setting screen for the security function. This makes a disguise as if the settings of the security function are changeable, and the third party having seen the setting screen re-realizes that the security function is provided. Thus, the effect of the disguise is enhanced.

The disguise section includes dedicated operation keys, and announces that the security function is provided when the operation keys are operated. It is possible, by placing the dedicated operation keys on the operation screen, to allow recognition as if the security function is provided at a glance. If the operation keys are operated, information on the security function is announced. The effect of the disguise that the security function is provided is enhanced.

A setting section for setting whether to enable or disable the disguise section is provided. It can be freely selected whether to perform the disguise and set the disguise section according to a purpose of use and a use environment of the image processing apparatus. In this case, setting by the setting section is allowed when a specific operation is performed. The specific operation allows setting of whether to enable or disable the disguise, and the setting is prohibited when no specific operation is performed. Thus, the setting can be performed only by a user who knows the specific operation such as a manager, and a general user who does not know the specific operation cannot perform the setting.

According to the present invention, a disguise is made as if the security function is being executed even if no security function is provided. Therefore, it gives a sufficient warning to a third party to curb the unauthorized use. Thus, a function of preventing leakage of the image data is provided to the apparatus having no security function so that the security can be improved.

### BRIEF DESCRIPTION OF THE DRAWINGS

FIG. 1 is a diagram showing a schematic configuration of an image processing apparatus of the present invention;

FIG. 2 is a diagram showing an operation panel;

FIG. 3 is a diagram showing an operation screen displaying information on a disguised security function;

FIG. 4 is a diagram showing a setting screen of the disguised security function;

FIG. 5 is a flowchart in the case of performing a disguised display in a copy mode;

FIG. 6 is a diagram showing a disguised screen indicating that data erasure is being executed;

FIG. 7 is a flowchart in the case of performing a disguised display in a scan mode;

FIG. 8 is a diagram showing a disguised screen indicating that data encryption is being executed;

FIG. 9 is a diagram showing a disguised screen indicating that data storage is being executed;

FIG. 10 is a flowchart in the case of performing a disguised display on turning on power; and

FIG. 11 is a diagram showing a disguised screen indicating that initialization is being executed.

### DETAILED DESCRIPTION OF THE PREFERRED EMBODIMENTS

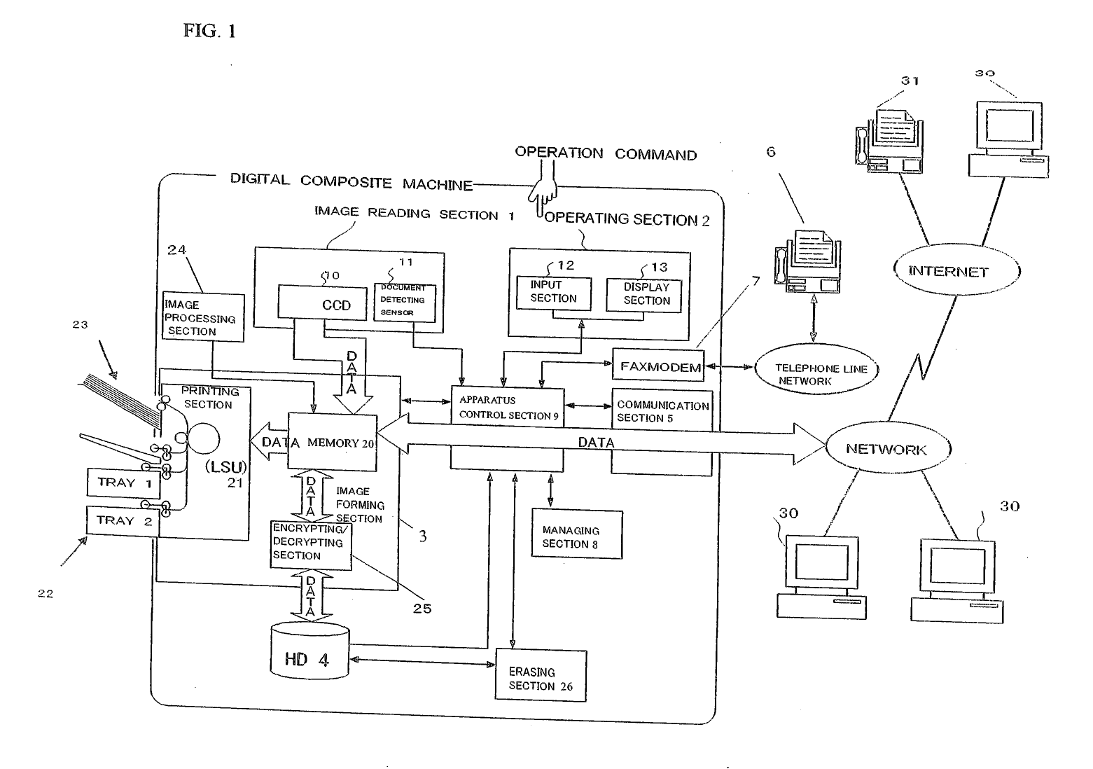

FIG. 1 shows an image processing apparatus of this embodiment. This image processing apparatus is a digital complex machine including a copy mode, a print mode, a scanner mode and a facsimile mode. The image processing apparatus includes an image reading section 1 for reading a document and inputting image data, an operating section 2 for receiving an input of a user, an image forming section 3 for printing inputted image data, a hard disk drive 4 for storing the image data! a communication section 5 for performing data communication with external devices, a FAX modem 7 for communicating with a facsimile apparatus 6, a management section 8 for storing control information and setting information on the entire apparatus, and a device control section 9 composed of a CPU for controlling the entire apparatus.

The image reading section 1 functions as an image data input section for inputting the image data, and includes image pickup devices such as a CCD 10 and a document detection sensor 11 for detecting a document set on a document tray or an automatic document feeder (ADF). The image data of images read by the CCD 10 is outputted to the image forming section 3.

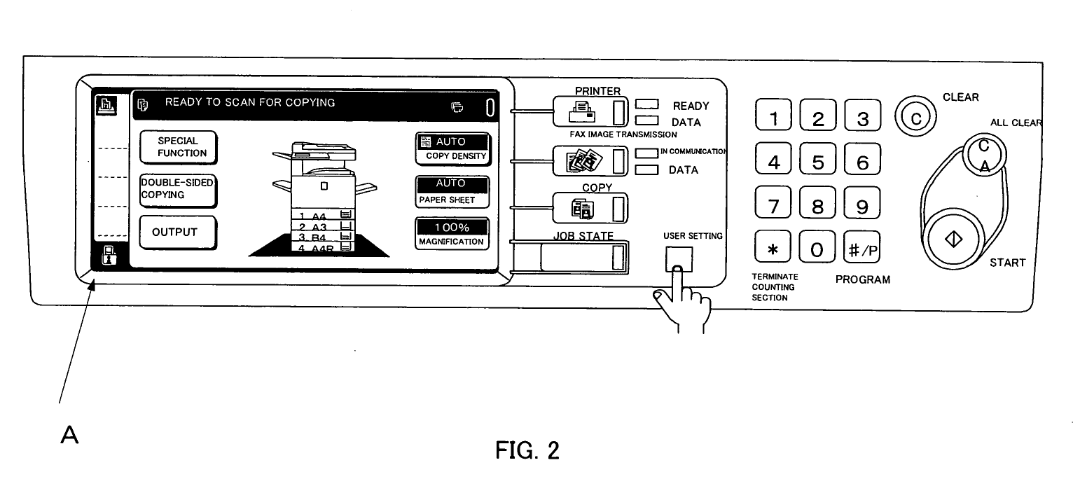

The operating section 2 includes an operation panel shown in FIG. 2, and has an input section 12 composed of various input keys and a display 13 such as a liquid crystal display. The display 13 is a touch panel which also functions as an input section. Operating instructions and various settings of the entire apparatus are inputted on the operating section 2, where input contents and operating conditions of the entire apparatus are displayed. The operating section 2 functions as an input section for receiving inputs of operating instructions.

The image forming section 3 includes a memory 20 for storing the inputted image data, a printing section 21 including a laser scanning unit, a paper feed section 22 including a manual tray and a cassette tray, a paper ejection section 23 including a paper ejection tray, an image processing section 24 and an encryption/decryption section 25.

The memory 20 uses a readable and writable semiconductor memory such as an SDRAM or a flash memory. The memory 20 is divided into an area for storing the inputted image data and an area for storing the image data to be outputted. It is also possible to use two memories 20 for input and for output respectively instead of dividedly using one memory 20.

In the image forming section 3, the inputted image data is stored in the memory 20. The memory 20 stores the image data by overwriting old image data with new image data. The image data undergoes image processing such as compression, extension and modification by the image processing section 24 so as to be stored in the memory 20. The image data having undergone the image processing is outputted to the printing section 21, the hard disk drive 4 or the device control section 9. The printing section 21 prints the images on recording sheets supplied from the paper feed section 22 based on the image data stored in the memory 20. Thus, the image forming section 3 functions as a processing section for processing the image data. The communication section 5 is connected to a router, a switching hub and the like via a LAN cable, and is also connected to a network formed by information processing apparatuses 30 such as personal computers and servers. The network is connected to the Internet via communication lines such as a telephone line network and optical fibers. The communication section 5 transmits and receives data to and from the information processing apparatuses 30 in the network, and also transmits and receives data and e-mail to and from external information processing apparatuses 30 via the Internet. The communication section 5 further performs Internet facsimile communication with a facsimile apparatuses 31 via the Internet. The FAX modem 7 is connected to a telephone line network via a telephone line, and performs facsimile communication with the external facsimile apparatus 6.

Thus, an image processing system is configured by the external apparatuses and multiple image processing apparatuses which are connected through the network. The image data is transmitted and received among the apparatuses.

The communication section 5 and FAX modem 7 receive the image data from the external apparatuses such as the information processing apparatuses 30, facsimile apparatuses 6 and 31 and input the received data. To be more specific, they function as an image data input section. When the image data is inputted from the external apparatuses, the communication section 5 simultaneously receives the input of operating instructions so as to function as the input section as well. Furthermore, the communication section 5 and FAX modem 7 transmit the image data to the external apparatuses and thereby functions as the processing section.

The device control section 9 executes a job to the inputted image data. To be more specific, the device control section 9 processes the inputted image data by controlling each section based on the information stored in the management section 8 according to the input from the operating section 2 and data input from the external apparatuses. Upon execution of the job, one of the copy mode, print mode, scanner mode and facsimile mode is executed according to the inputted image data, and the image is outputted in a desired form.

The hard disk drive 4 temporarily stores the image data. The encryption/decryption section 25 encrypts or decrypts the image data. When the image data is stored in the hard disk drive 4, the image data is encrypted by the encryption/decryption section 25. When reading the encrypted image data from the hard disk drive 4, the image data is decrypted.

The hard disk drive 4 stores management information on data processing as the data other than the image data. The management information includes filing management information, destination management information and history management information. The filing management information is a list of files in which the inputted image data is stored. The destination management information is a list of destinations in facsimile communication. The history management information is a list of executed process contents.

An erasure section 26 for erasing the image data of the hard disk drive 4 is provided. The image data to be erased is the data stored in a processing task area. The device control section 9 controls operation of the erasure section 26 after processing and outputting the image data. The erasure section 26 overwrites random data and meaningless data or erases the data, thereby rendering the stored image data unreadable, and invalidates the data so that an original image cannot be reproduced. As for the memory 20, the erasure section 26 may also invalidate the image data therein by overwriting and erasing old image data or erasing the image data. The management information stored in the hard disk drive 4 is not erased unless there is an instruction from the device control section 9.

Here, a security function exists to prevent leakage of the image data and protect it. As shown in FIG. 2, in the case of the image processing apparatus having the security function, a security mark A is displayed on the operation screen shown on the display 13. The mark A is the operation key for security.

On processing the image data, the device control section 9 executes the security function. As for the security function, the following can be included: erasing the image data stored in the hard disk drive 4 and memory 20 by the erasure section 26 on finishing a job; encrypting the inputted image data by the encryption/decryption section 25 and then storing it in the hard disk drive 4 and memory 20; erasing the image data stored in the hard disk drive 4 and memory 20 by the erasure section 26 on turning on power; and encrypting and transmitting the image data.

When such a security function is executed, the device control section 9 announces it by displaying a message indicating that the function is being executed on the display 13.

However, the image processing apparatus does not have the security function. Thus, the device control section 9 includes a disguise section for behaving as if executing an unprovided security function when operating based on an operating instruction. To be more specific, the disguise section indicates that the security function is in execution on the display 13 in conjunction with processing of the image data according to the operating instruction.

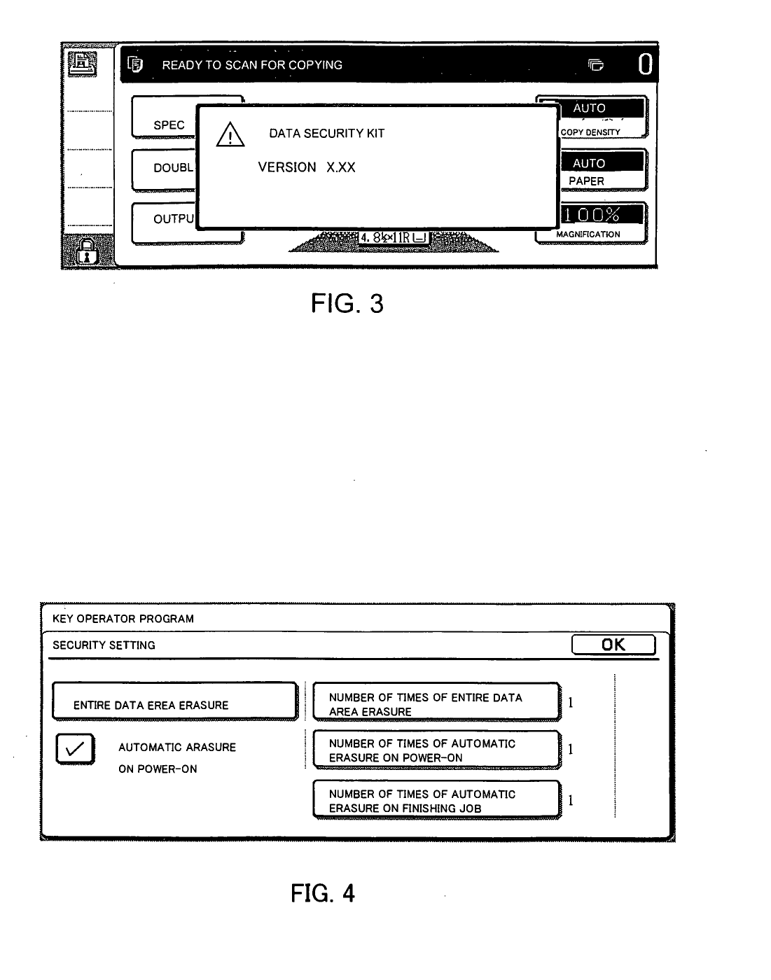

The disguise section operates the display 13 to display the security mark A shown in FIG. 2 on the operation screen. The mark A is a dedicated operation key. When the operation key is operated, the disguise section receives the operating instruction and displays information on the security function on the operation screen as shown in FIG. 3. The screen displayed here is made by imitating a genuine display screen.

Various functions can be set by operating a user setting key on the operation screen shown in FIG. 2. Even if the security function is not provided, however, the disguise section displays a security setting screen as shown in FIG. 4. Input operation is possible on the security setting screen. When an input is performed, the device control section 9 changes the operation screen according to the input but does not store setting information. Thus, the image processing apparatus behaves as if the security function is provided even if it is not provided.

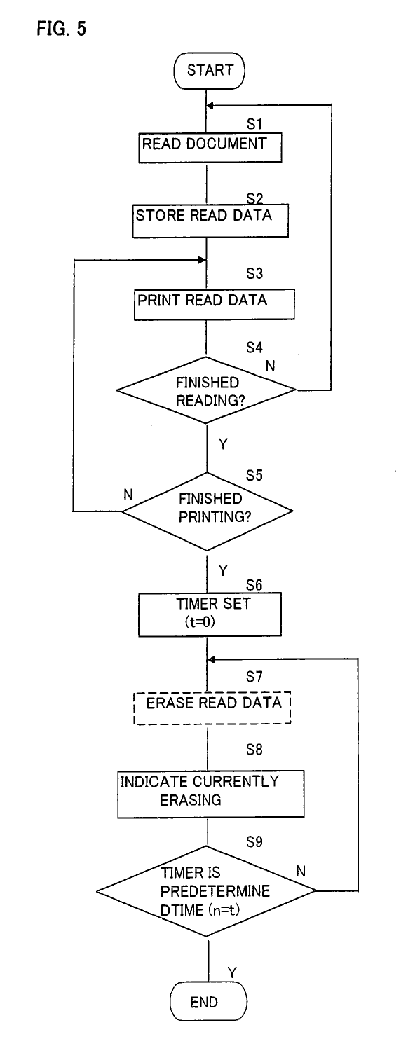

And when executing each of the modes, the disguise section operates. When in the copy mode as shown in FIG. 5, the image data of the document is read by the image reading section 1 (S1). The device control section 9 stores the inputted image data in the hard disk drive 4 (S2). The image data is expanded in the memory 20 and image-processed by the image processing section 24. Thereafter, the image data is outputted to the printing section 21 and printed (S3).

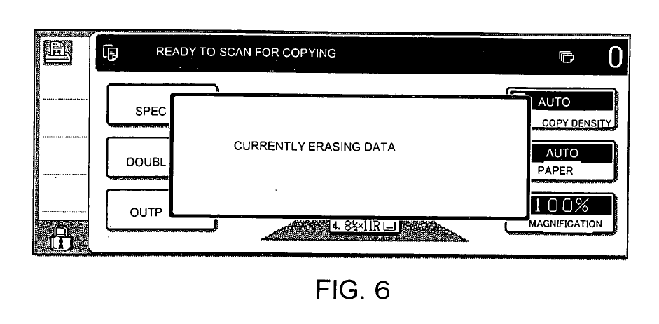

When reading of the entire document is finished (S4) and the printing is finished (S5), the disguise section starts operation. A timer of the device control section 9 starts counting (S6), and the disguise section displays a message of erasing the image data as shown in FIG. 6 (S8). In the case where the security function is provided, the image data is erased by the erasure section (S7). However, the erasure section 26 does not operate, and the stored image data is not erased. While the image data remains stored in the hard disk drive 4 and memory 20, old image data is overwritten by new image data when storing the new image data.

The message is displayed for t seconds (S9), and the job is finished. Time for the display is the same as the time for actually erasing the image data by the security function, which is 3 to 5 seconds for instance.

When in the print mode, it is the same as when in the copy mode. After the image data inputted from the information processing apparatuses 30 is printed, the message of erasing the image data is displayed although the image data is not erased.

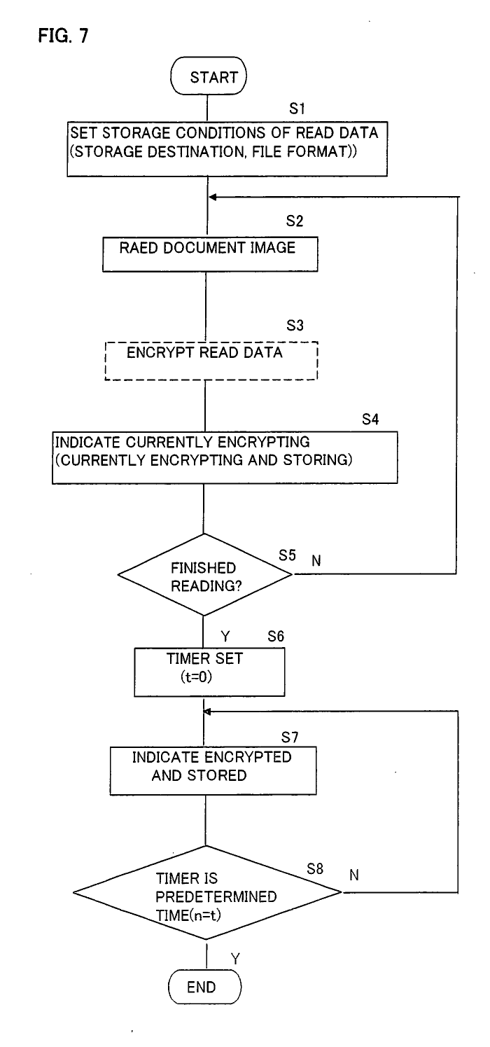

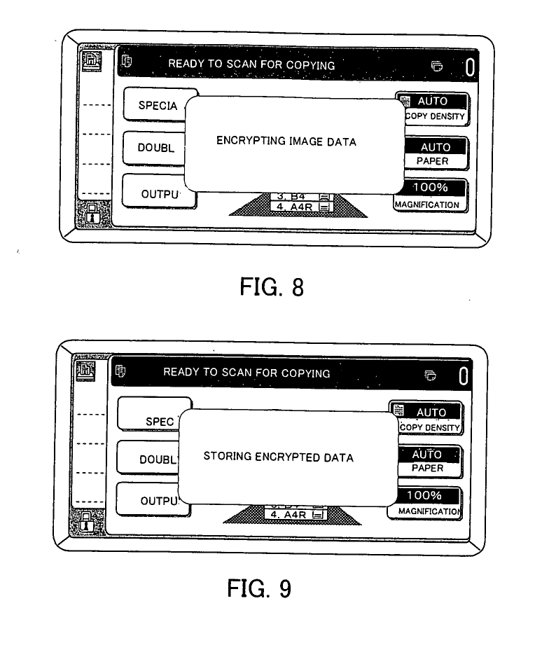

When in the scanner mode as shown in FIG. 7, storage conditions such as a storage destination of the image data to be inputted are set up (S1), and the image data of the document is read by the image reading section 1 (S2). The device control section 9 stores the inputted image data in the set-up storage destination. In the case where the security function is provided, the image data is encrypted and stored (S3). Here, the image data is stored without being encrypted. In this case, the disguise section displays a message to the effect that the image data is being encrypted as shown in FIG. 8 (S4).

When reading of the entire document is finished (S5), the timer of the device control section 9 starts counting (S6), and the disguise section displays a message to the effect of storing the encrypted image data (S7) as shown in FIG. 9. The message is displayed for t seconds (S8), and the job is finished.

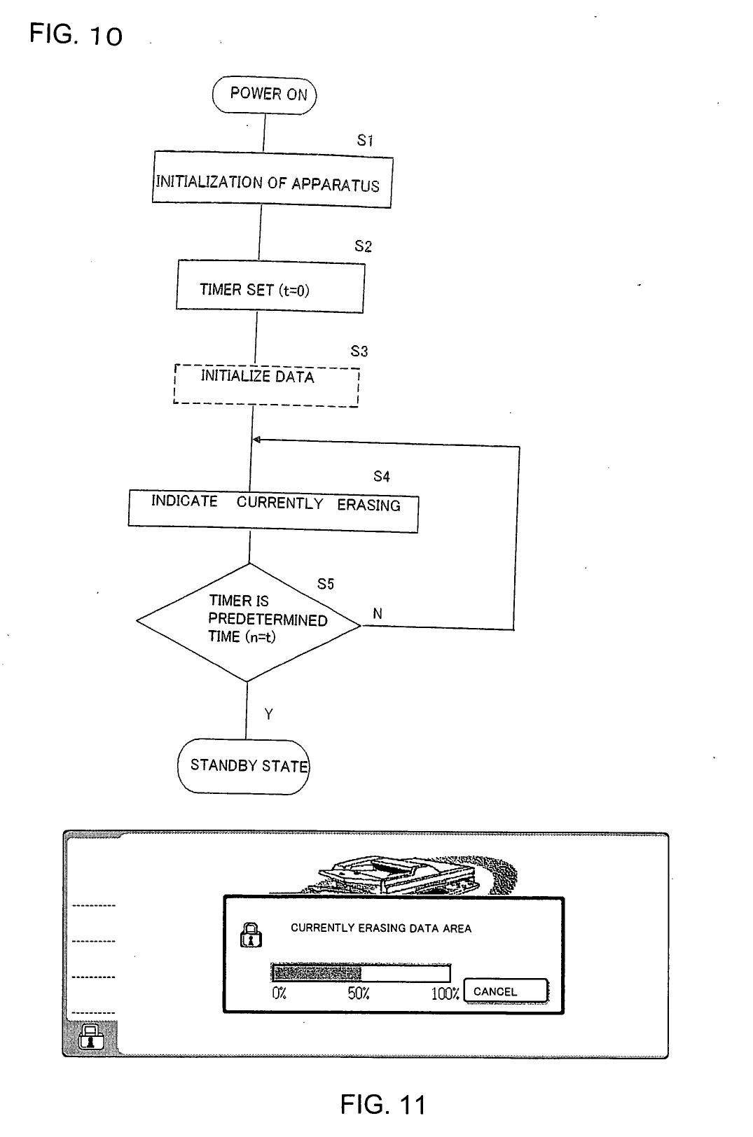

As shown in FIG. 10, the image processing apparatus is initialized when the apparatus is powered on and started up (S1). The timer of the device control section 9 starts counting (S2). In the case where the security function is provided, the erasure section 26 erases the data stored in the processing task area of the hard disk drive 4 to initialize the hard disk drive 4 (S3). Here, such initialization is not performed, and the disguise section displays a message of currently erasing as shown in FIG. 11 (S4). The message is displayed for t seconds (S5), and the image processing apparatus is put in a standby state.

If an operating instruction is inputted by the user's operation, the operation of image processing is performed. In this case, a message of currently executing the security function is displayed so that the user becomes conscious that the security function is provided. Therefore, when a malicious third party operates it, the third party recognizes that the security function is provided and stops the operation. Thus, it is possible to curb unauthorized use by the third party and prevent leakage of the image data.

It is settable whether to enable or disable the disguise section. The device control section 9 includes the setting section for setting whether to enable or disable the disguise section. This setting can be performed by a manager who is permitted based on authentication information such as a password. To be more specific, if a specific operation such as inputting a password is performed, the setting section verifies the authentication information inputted by this operation. Upon authenticating the authentication information, the setting section displays the setting screen to set whether to enable or disable the disguise section. When the authentication information cannot be authenticated, the setting screen is not displayed. The specific operation may be an operation for inputting biologic information. The setting section authenticates the biologic information so as to verify whether or not it is the manager. The specific operation may also be a particular operation of the operation keys, such as sequentially operating multiple operation keys or simultaneously operating multiple operation keys.

Thus, only the manager can perform the specific operation, and so the manager is allowed to set the disguise section. A general user cannot perform the specific operation, and so the general user is not authenticated and the setting by the general user is prohibited. Therefore, when the disguise section is enabled, only the manager recognizes that the security function is not provided while other users recognize that the security function is provided. It is accordingly possible, even if no security function is provided, to disguise it as an image processing apparatus of high security so as to prevent the unauthorized use.

The present invention is not limited to the embodiment. It is possible, as a matter of course, to add a large number of modifications and changes to the embodiment within the scope of the present invention. As an image processing apparatus, it may be either a complex machine including a copy mode and a print mode or a dedicated machine of a single mode such as a copier, a scanner or a printer.

The disguise section may also announce by voice, other than the display, that the security function is being executed. It may also behave as if executing a function other than the security function. The other functions may include a function related to handling of the image data, such as an authentication function. Even if the authentication function is not provided, the disguise section requests the authentication information such as a password to be inputted when an operating instruction to output the stored image data is given, and indicates that the authentication information cannot be authenticated when the authentication information is inputted. Thus, the third party presumes that the authentication is necessary and stops the operation, thus resulting in the effect of preventing the unauthorized use by the third party, provided that a legitimate user is aware that the disguise is being performed. And an operation for avoiding the disguise is set up so as to continue the processing when that operation is performed.

As for the annunciation by the disguise section, it may be announced not only by the image processing apparatus but also by an external apparatus such as an information processing apparatus which is connected to the image processing apparatus through a network. When an operating instruction for image processing is given from the information processing apparatus for instance, the disguise section announces that the security function is being executed. To be more specific, the image processing apparatus transmits the operating conditions to the information processing apparatus. In this case, a message that the security function is being executed is also transmitted by the disguise section. The information processing apparatus displays the message on the screen.

What is claimed is:

1. An image processing apparatus comprising:
a processing section for processing image data;
an input section for receiving an input of an operating instruction; and
a disguise section for behaving as if executing an unprovided function when the processing section operates based on the operating instruction.

2. The image processing apparatus according to claim 1, wherein the disguise section announces that a security function related to processing of the image data is being executed.

3. The image processing apparatus according to claim 2, wherein:
the processing section reads the image data from a document; and
the disguise section operates during processing of the read image data.

4. The image processing apparatus according to claim 2, wherein:
the processing section prints the image data; and
the disguise section operates on printing.

5. The image processing apparatus according to claim 2, wherein the disguise section operates on start-up.

6. The image processing apparatus according to claim 2, wherein:
the input section displays a setting screen of provided functions; and
the disguise section displays a setting screen for the security function on the setting screen.

7. The image processing apparatus according to claim 6, wherein the input section allows operations on the setting screen for the security function.

8. The image processing apparatus according to claim 1, wherein the disguise section includes dedicated operation keys and announces that the security function is provided when the operation keys are operated.

9. The image processing apparatus according to claim 1, further comprising a setting section for setting whether to enable or disable the disguise section.

10. The image processing apparatus according to claim 9, wherein setting by the setting section is allowed when a specific operation is performed.
